(19) United States
(12) Patent Application Publication
(10) Pub. No.: US 2025/0389609 A1
(43) Pub. Date: Dec. 25, 2025

(54) METHODS AND APPARATUS FOR LEAKAGE IDENTIFICATION

(71) Applicant: The Boeing Company, Arlington, VA (US)

(72) Inventors: Uddip Kashyap, Guwahati (IN); Amar Patel, Waraseoni (IN)

(21) Appl. No.: 18/750,611

(22) Filed: Jun. 21, 2024

(51) Int. Cl. G01M 3/18; B64D 45/00

(52) U.S. Cl. CPC G01M 3/18; B64D 45/00

(57) ABSTRACT

Methods and apparatus for leakage identification are disclosed. A disclosed example apparatus to determine at least one of a presence of a leak or a characteristic of the leak corresponding to a target, includes a liquid sensor corresponding to the target, the liquid sensor including first and second electrodes, and a liquid transport material, wherein at least a portion of the liquid transport material is positioned between the first and second electrodes, and an inductor-capacitor resonance circuit electrically coupled to the first and second electrodes, the inductor-capacitor resonance circuit to measure a self-capacitance of the liquid sensor.

### FIELD OF THE DISCLOSURE

This disclosure relates generally to leak detection and, more particularly, to methods and apparatus for leakage identification.

### BACKGROUND

For aircraft applications, leakage of fluid for an electro-mechanical system can have far reaching impacts and even impair operation thereof. Leakages, such as a small seepage or crack can occur at a relatively constant flow rate. In other scenarios, bursting of a fluidic system and/or component can result in a sudden increase of liquid flow.

### SUMMARY

An example apparatus to determine at least one of a presence of a leak or a characteristic of the leak corresponding to a target, includes a liquid sensor corresponding to the target, the liquid sensor including first and second electrodes, and a liquid transport material, wherein at least a portion of the liquid transport material is positioned between the first and second electrodes, and an inductor-capacitor resonance circuit electrically coupled to the first and second electrodes, the inductor-capacitor resonance circuit to measure a self-capacitance of the liquid sensor.

An example at least one non-transitory machine-readable medium includes machine-readable instructions to cause at least one processor circuit to at least determine a self-capacitance of a liquid sensor with respect to time based on output from a resonance circuit, the liquid sensor electrically coupled to conductors of a capacitor of the resonance circuit, the resonance circuit including a voltage source to supply power to the capacitor and an inductor of the resonance circuit, the liquid sensor including or in contact with a liquid transport material corresponding to a moisture target, and determine at least one of a presence of a leak or a characteristic of the leak based on the determined self-capacitance with respect to time.

An example resonance circuit for leakage identification in a vehicle includes an inductor, a capacitor in series with the inductor, a first lead of the capacitor electrically coupled to a first conductor of a liquid sensor, a second lead of the capacitor electrically coupled to a second conductor of the liquid sensor, the liquid sensor in contact with a liquid transport material, and a voltage source across the inductor and the capacitor.

An example method includes measuring a self-capacitance across a leak sensor associated with a transport material proximate to or at a target, generating a curve corresponding to the self-capacitance of the leak sensor with respect to time, and determining at least one of a presence of leak or a characteristic of the leak based on the curve.

### BRIEF DESCRIPTION OF THE DRAWINGS

FIG. 1 illustrates an example aircraft in which examples disclosed herein can be utilized.

FIGS. 2A and 2B illustrate an example sensing arrangement in accordance with teachings of this disclosure.

FIGS. 3A and 3B illustrate an alternative example sensing arrangement in accordance with teachings of this disclosure.

FIG. 4 is a schematic overview of an example liquid sensing system in accordance with teachings of this disclosure.

FIGS. 5A-5G are example graphs illustrating an example analysis in accordance with teachings of this disclosure.

FIGS. 6A-6F are example graphs illustrating an example analysis in accordance with teachings of this disclosure.

FIG. 7 is a schematic overview of a leakage analysis system that can be implemented in examples disclosed herein.

FIG. 8 is a flowchart representative of example machine readable instructions and/or example operations that may be executed, instantiated, and/or performed by example programmable circuitry to implement the example leakage analysis system of FIG. 7 and/or the example liquid sensing system of FIG. 4.

FIG. 9 is a block diagram of an example processing platform including programmable circuitry structured to execute, instantiate, and/or perform the example machine readable instructions and/or perform the example operations of FIG. 8 to implement the example leakage analysis system of FIG. 7 and/or the example liquid sensing system of FIG. 4.

FIG. 10 is a block diagram of an example implementation of the programmable circuitry of FIG. 9.

FIG. 11 is a block diagram of another example implementation of the programmable circuitry of FIG. 9.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus for leakage identification are disclosed. In known implementations, detection of leakage for a fluidic system can be continuous or periodic. Some known technologies are pressure-based while other known implementations utilize ultrasonic technology that incorporates optical fiber based for continuous monitoring. However, for known systems, relatively little information is known beyond whether a leak is present. Further, these known systems can have relatively high costs. Moreover, for relatively complex systems, multiple fluid flows through a particular system or multiple systems can be combined, thereby increasing a difficulty of analyzing the same. Data analytics and machine learning have been recently employed for leakage determination. However, these solutions necessitate specific conditions for relatively accurate results and/or determinations.

For known systems, in-pipe methods may yield increased resolution when high resolution sensors are utilized in conjunction with data monitoring. Pressure sensors are expensive and can only monitor a limited area of a pipe. Ultrasonic devices are bulky and not favorable for onboard continuous detection for aircraft. Optical cables can yield data with a relatively high resolution. However, optical cables are expensive and generally supported by existing pipelines. Further, results associated with optical cables are significantly affected by reflection from surrounding pipelines. Further, optical cable-based systems also depend on a difference of temperature between flowing fluid and a surrounding pipeline.

Example disclosed herein enable cost-effective and accurate determination and/or characterization of leaks. Examples disclosed herein can accurately determine a presence of a leak at a relatively early stage, thereby avoiding downtime associated with relatively severe leaks. Examples disclosed herein can also effectively characterize leaks. For example, examples disclosed herein can determine leakage rates and/or identify a type of liquid that has leaked.

Examples disclosed herein utilize a liquid sensor that is proximate and/or attached to a moisture target, such as a pipe, valve, fluid interchange, etc. The liquid sensor is utilized in conjunction with an inductor-capacitor resonance circuit. In particular, the aforementioned example inductor-capacitor resonance circuit is utilized to determine a self-capacitance of the liquid sensor. In turn, the determined self-capacitance can be utilized to determine a presence of a leak and/or characteristics of the leak. According to examples disclosed herein, a liquid transport material (e.g., fluid wicking material, etc.), such as cotton fibers, wicking fibers, wicking material, etc., are utilized to facilitate movement of liquid toward and/or into the liquid sensor. For example, the liquid transport material can direct the liquid to space between electrical contacts of the liquid sensor.

In some examples, a curve or other representation of the self-capacitance is generated (e.g., with respect to time). In some such examples, a slope of the curve is utilized to determine a leakage rate. Additionally or alternatively, a liquid is identified (e.g., water, oil, brake fluid, etc.) based on the slope. In some examples, electrodes of a capacitor of the inductor-capacitor resonance circuit are electrically coupled to conductors of the liquid sensor. The conductors of the liquid sensor may include spaced apart and/or offset plates and/or leads. In some examples, at least one of the conductors of the liquid sensors includes apertures or openings to facilitate the movement of fluid toward a space/volume that is situated between the conductors. In some examples, a microcontroller is operatively/electrically coupled to the inductor-capacitor resonance circuit. According to some examples disclosed herein, the microcontroller can wirelessly transmit output (e.g., leaking indications, leakage data) to a vehicle/aircraft control system.

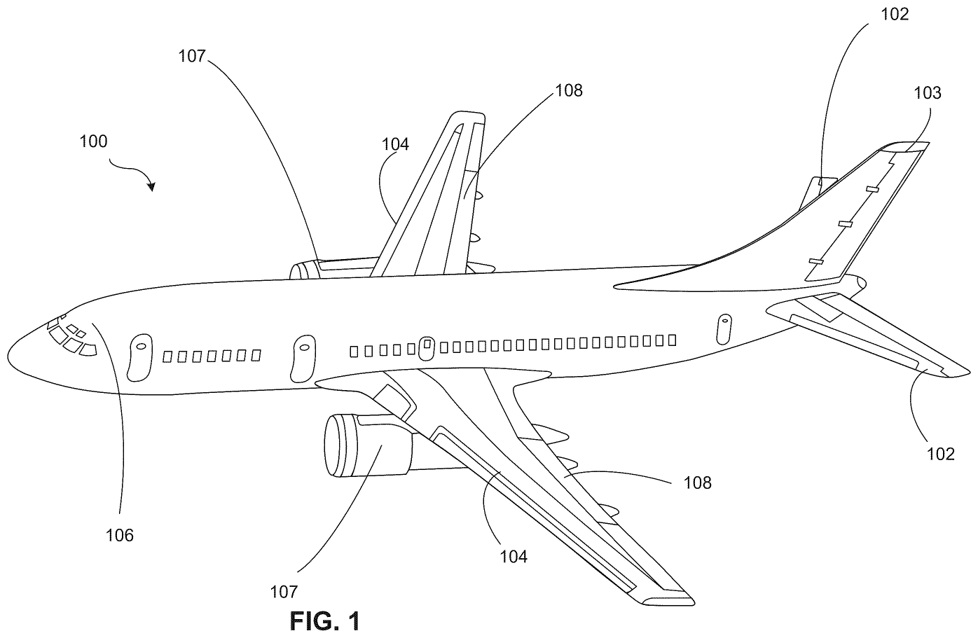

FIG. 1 illustrates an example aircraft 100 in which examples disclosed herein can be implemented. In particular, examples disclosed herein can be utilized to produce components and/or parts associated with the aircraft 100, for example. In the illustrated example of FIG. 1, the aircraft 100 includes horizontal tails 102, a vertical tail 103 and wings (e.g., fixed wings) 104 attached to a fuselage 106. The wings 104 of the illustrated example have engines 107, and control surfaces (e.g., flaps, ailerons, tabs, etc.) 108, some of which are located at a trailing edge or a leading edge of the wings 104. The control surfaces 108 may be displaced or adjusted (e.g., deflected, etc.) to provide lift during takeoff, landing and/or flight maneuvers.

In the illustrated example of FIG. 1, internal components and/or assemblies are located in the fuselage 106 (and other external components) of the aircraft 100. Examples disclosed herein can be applied to any appropriate internal or external structure and/or vehicle. Accordingly, examples disclosed herein can be utilized for rotorcraft, spacecraft, watercraft, submersibles, unmanned aerial vehicles, or stationary structures, etc. Examples disclosed herein can be utilized for any appropriate structure that can be adversely affected by fluid leaks, for example. In a particular scenario, examples disclosed herein can effectively determine a presence and/or characterization of a leak present on a vehicle, for example.

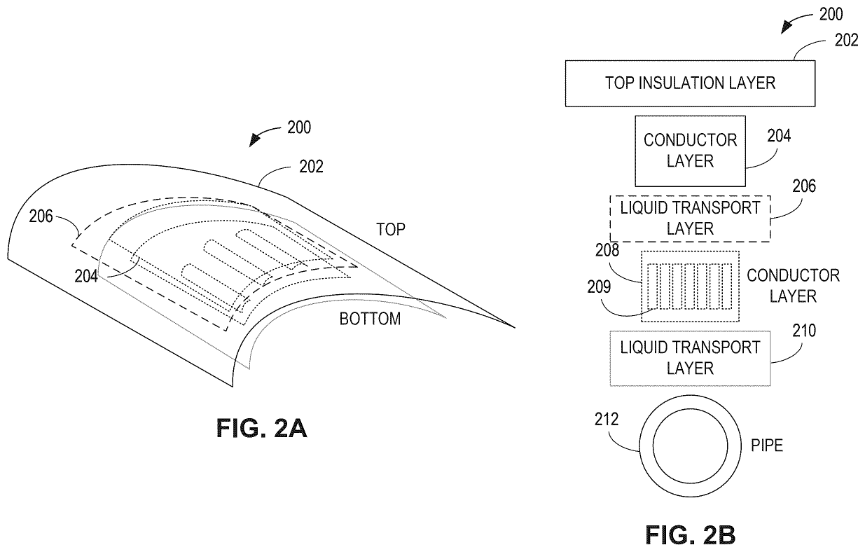

FIGS. 2A and 2B illustrate an example sensing arrangement (e.g., liquid sensor) 200 in accordance with teachings of this disclosure. Referring to FIG. 2A, the sensing arrangement 200 is implemented onto a curved surface and/or panel of a vehicle, such as an aircraft, for example. FIG. 2B depicts the sensing arrangement 200 as a simplified layer representation. In the illustrated example, the sensing arrangement 200 includes a layered construction (e.g., an external skin layer, an insulation layer, a panel, etc.) 202 having a first conductor (e.g., a metal layer, an electrode layer, a conductor layer, etc.) 204, a first liquid transport 206, a second conductor (e.g., a metal layer, an electrode layer, a conductor layer, etc.) 208 having apertures 209 extending therethrough, and a second liquid transport 210. In this example, the sensing arrangement 200 is placed proximate, in contact with or at a target (e.g., a moisture target) 212, which is a pipe in this example. In particular, the example sensing arrangement may be wrapped around a periphery (e.g., an outer surface) of the pipe.

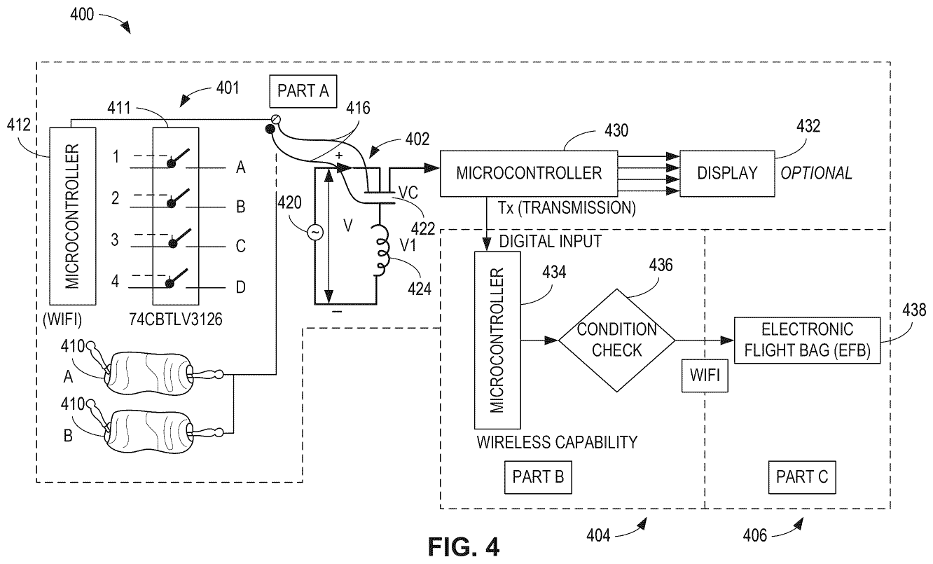

To measure a self-capacitance in an area/volume between the first conductor 204 and the second conductor 208, the sensing arrangement 200 of the illustrated utilizes the first conductor 204 and the second conductor 208, both of which spaced apart from one another with at least a portion of the first liquid transport 206 positioned therebetween. As shown in connection with FIG. 4, the first conductor 204 and the second conductor 208 can be electrically coupled to a capacitor of an inductor-capacitor resonance circuit and moisture can be drawn/transported therebetween by the first liquid transport 206. Accordingly, the moisture present in the area between the first conductor 204 and the second conductor 208 affects capacitance measured at the capacitor of the inductor-capacitor resonance circuit. According to examples disclosed herein, the capacitance value can correspond to a presence of a leak, characteristics of the leak and/or liquid characteristics.

To facilitate movement of liquid from the target 212, the liquid transport 206 is implemented for identification of the leak and/or characterization of the leak based on the self-capacitance. To that end, the example second conductor 210 includes the aforementioned apertures 209. In this example, moisture/fluid/liquid from the target 212 is drawn and/or transported by the second liquid transport 210 and passes through the apertures 209 to the first liquid transport 206, thereby affecting a self-capacitance measurement between the first conductor 204 and the second conductor 208.

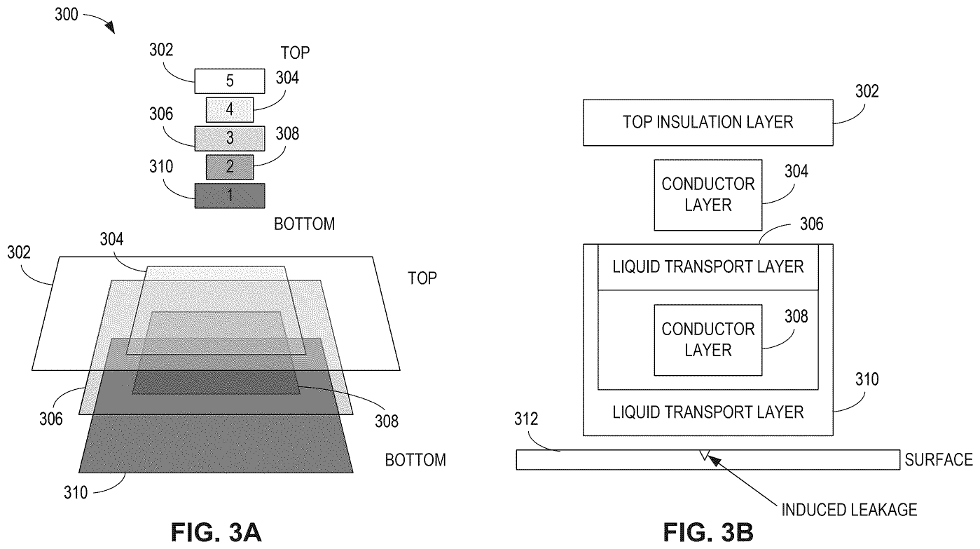

FIGS. 3A and 3B illustrate an alternative example sensing arrangement (e.g., liquid sensor) 300 in accordance with teachings of this disclosure. FIG. 3A depicts an example cross-sectional overview while FIG. 3B depicts a simplified layer representation of the example sensing arrangement 300. Referring to FIGS. 3A and 3B, the sensing arrangement 300 of the illustrated example includes an insulation 302 a first conductor (e.g., a metal layer, an electrode layer, a conductor layer, etc.) 304, a first liquid transport (e.g., a first liquid transport layer) 306, a second conductor (e.g., a metal layer, an electrode layer, a conductor layer, etc.) 308, and a second liquid transport (e.g., a second liquid transport layer) 310.

Similar to the example sensing arrangement (e.g., liquid sensor) 200 of FIGS. 2A and 2B, the example sensing arrangement 300 is utilized to measure a self-capacitance between the first conductor 304 and the second conductor 308. In this example, the first liquid transport 306 between the first conductor 304 and the second conductor 308 is in contact with and/or coupled to the second liquid transport 310. According to examples disclosed herein, at least one of the first liquid transport 306 or the second liquid transport 310 at least partially surrounds the second conductor layer. In this example, liquid/moisture from a target 312 is drawn to the second liquid transport 310 and, in turn, moves and/or is transported to (e.g., via wicking) to the first liquid transport 306. Accordingly, the liquid present in the first liquid transport 306 affects self-capacitance measured between the first electrode 304 and the second conductor 308 for leak presence identification and/or leak characterization.

FIG. 4 is a schematic overview of an example liquid sensing system 400 in accordance with teachings of this disclosure. The example liquid sensing system 400 includes a sensing portion 401, a circuit (e.g., a sensing circuit, an inductor-capacitor resonance circuit, etc.) 402, a transmitter 404 and a vehicle control system 406, which is an electronic flight bag (EFB) implementation in this example.

The sensing portion 401 of the illustrated example includes liquid sensors 410, which can implement the liquid sensing arrangements (e.g., liquid sensors) 200, 300 shown in FIGS. 3A-4B, a switch (e.g., a switch relay) 411, and a microcontroller 412. Further, in this example, leads 416 extend from the sending portion 401. The example circuit 402 includes a power/voltage source 420, a capacitor 422, and an inductor 424. In this example, the capacitor 422 is in series with the inductor 424, and parallel to the power/voltage source 420. In turn, the circuit 402 is electrically coupled to an example microcontroller 430 and, in some examples, a display 432. In the illustrated example of FIG. 4, a microcontroller 434 is communicatively coupled to the microcontroller 430 and a condition check 436 that is in wireless communication with an EFB 438.

In operation, the example microcontroller 412 controls the switch 411 to switchably and/or periodically couple the circuit 402 to ones of the liquid sensors 410. As a result, when the liquid sensor 410 is electrically coupled to the circuit 402, the circuit 402 is utilized to measure a self-capacitance of the electrically coupled liquid sensor 410. In particular, the leads 416 are electrically coupled to conductors (e.g., conductor plates, conductor leads, etc.) of the capacitor 422. In this example, the microcontroller 430 includes and/or causes a transmitter to transmit output corresponding to capacitance of at least one of the liquid sensors 410. According to examples disclosed herein, the microcontroller 434 is to analyze and/or utilize the output from the microcontroller 430 and the condition check 436 utilizes the output to determine a condition associated with the liquid sensor 410 and/or an associated component/device/assembly.

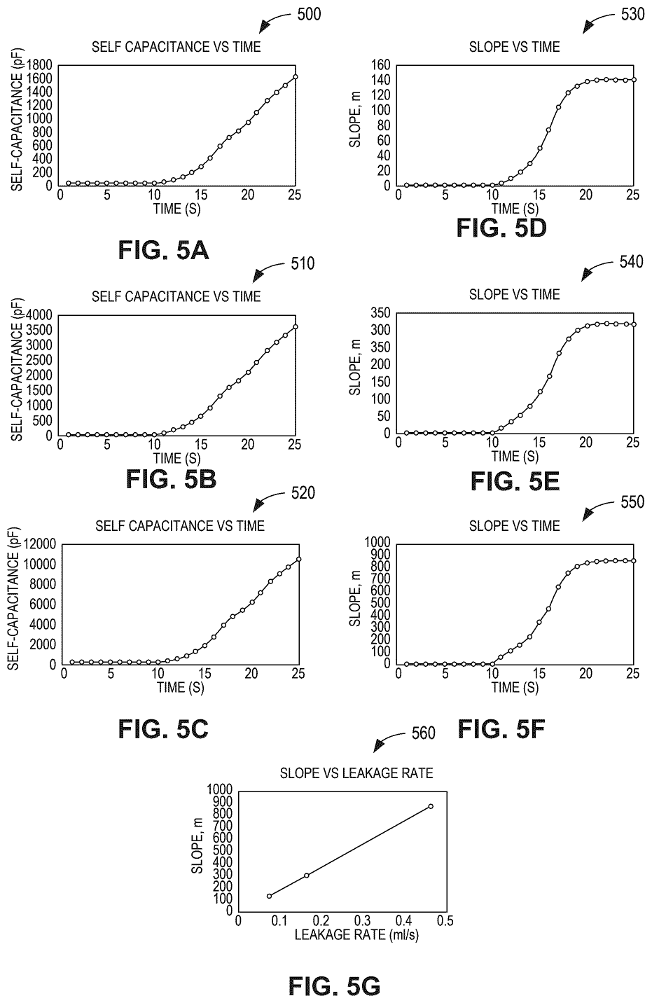

FIGS. 5A-5G are example graphs illustrating an example analysis in accordance with teachings of this disclosure. FIGS. 5A-5C include graphs 500, 510, 520, respectively, which relate self-capacitance as a function of time for different leakage rates. In particular, the slopes of the graphs 500, 510, 520 can be utilized to determine leakage rates.

FIGS. 5D-5F include graphs 530, 540, 550, which relate self-capacitance slopes as a function of time. In particular, the graphs 530, 540, 550 correspond to derivatives of the graphs 500, 510, 520, respectively.

FIG. 5G depicts a graph 560 that relates slope as a function of leakage rate. According to examples disclosed herein, measuring the slope of a self-capacitance chart can be utilized to determine a leakage rate.

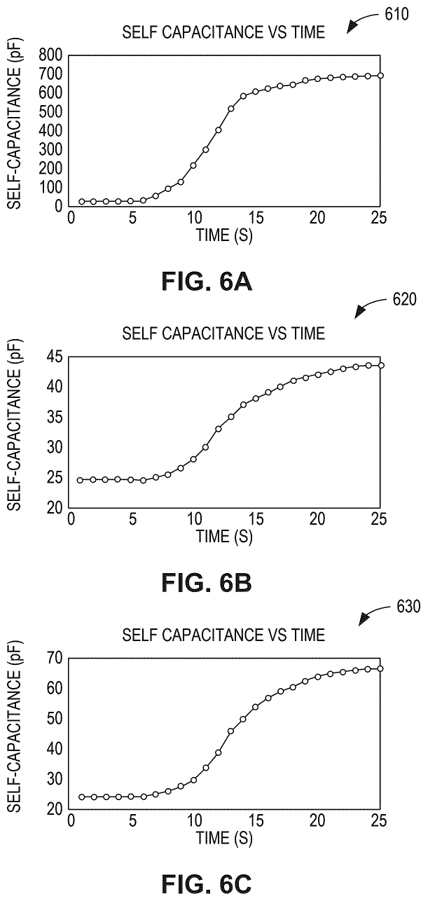

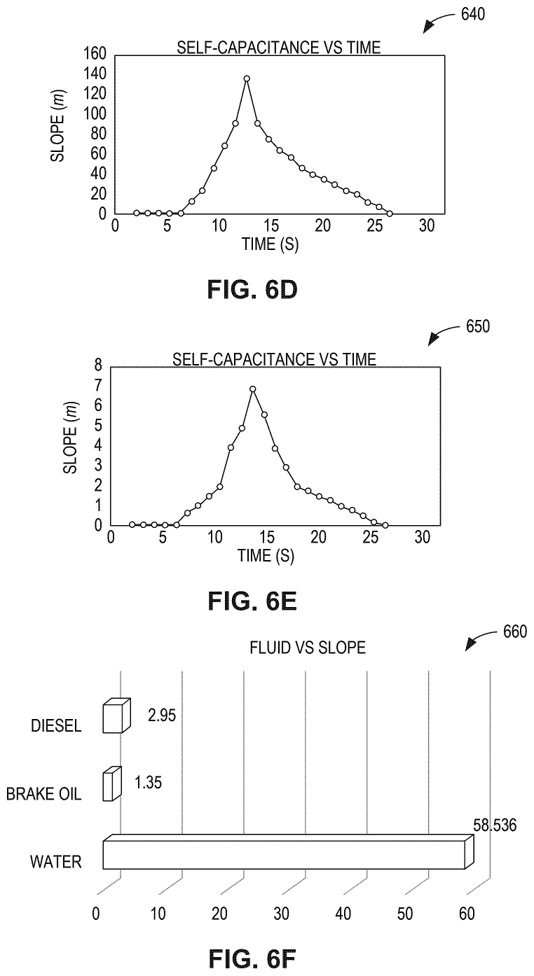

FIGS. 6A-6F are example graphs illustrating an example analysis in accordance with teachings of this disclosure. FIGS. 6A-6C include graphs 610, 620, 630 representing self-capacitance with respect to time for different types of liquids.

FIGS. 6D and 6E include example graphs 640, 650, respectively, that relate slopes of self-capacitance with respect to time for different fluids.

FIG. 6F is an example graph 660 representing slopes of different fluids. As can be seen in FIG. 6F, different fluids can have significantly different slopes, Accordingly, examples disclosed herein can determine a type of liquid in a relatively accurate manner.

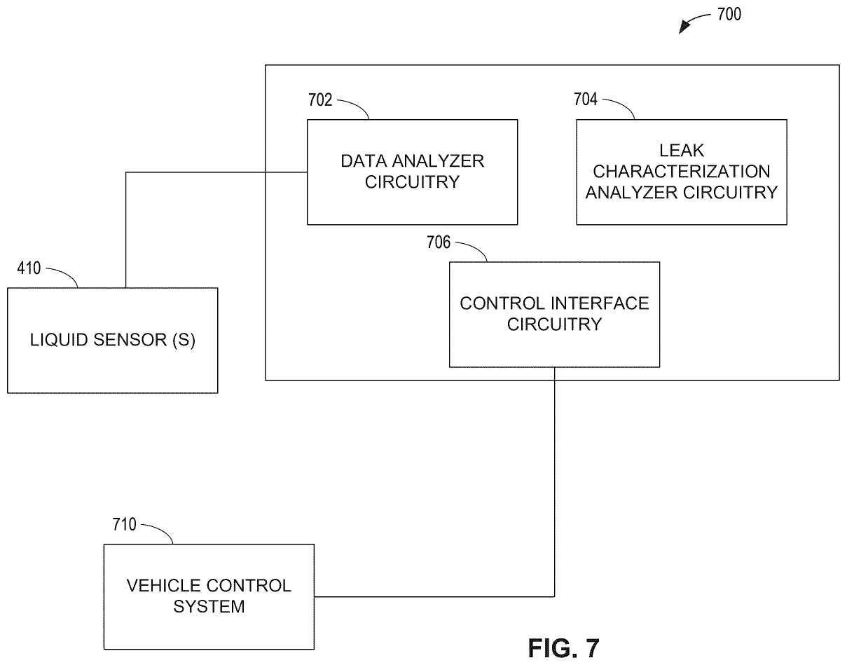

FIG. 7 is a block diagram of an example implementation of an example leakage analysis system 700 to analyze and/or determine leak occurrences/conditions. The leakage analysis system 700 of FIG. 7 may be instantiated (e.g., creating an instance of, bring into being for any length of time, materialize, implement, etc.) by programmable circuitry such as a Central Processor Unit (CPU) executing first instructions. Additionally or alternatively, the leakage analysis system 700 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

The example leakage analysis system 700 of the illustrated example includes example data analyzer circuitry 702, example leak characterization circuitry 704, and example condition determination circuitry 706. According to examples disclosed herein, the leakage analysis system 700 is communicatively coupled to and/or includes the liquid sensor 410 and/or the sensing portion 401 of FIG. 4. Further, the leakage analysis system 700 can be part of, include and/or be communicatively coupled to a vehicle control system 710.

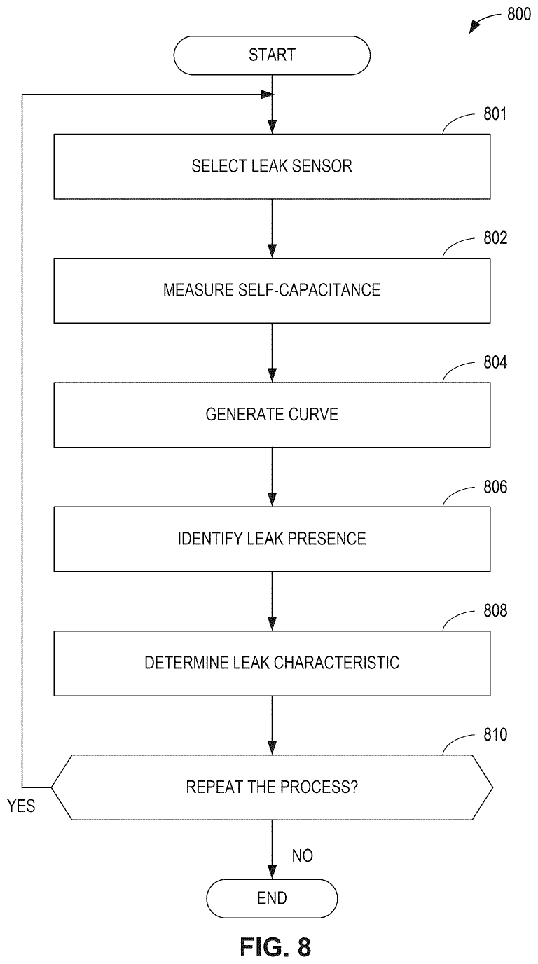

The example data analyzer circuitry 702 is utilized to process. characterize and/or analyze data from the liquid sensor 410, which may be selected by the switch 411 shown in FIG. 4. In this example, the data analyzer circuitry 702 utilizes output and/or signals from the liquid sensor 410 (via the circuit 402) to determine a self-capacitance of the liquid sensor 410. In particular, the self-capacitance of the liquid sensor 410 varies based on characteristics of fluid/moisture present between contacts of the liquid sensor 410. In some examples, the data analyzer circuitry 702 is instantiated by programmable circuitry executing data analyzer instructions and/or configured to perform operations such as those represented by the flowchart of FIG. 8.

The leak characterization circuitry 704 of the illustrated example determines a presence of a leak based on the aforementioned self-capacitance. According to examples disclosed herein, the leak characterization circuitry 704 can generate a curve, a graph and/or a data array associated with the self-capacitance for determination of a leak parameter. In some examples, a curve that relates self-capacitance with respect to time is generated (e.g., a self-capacitance history). In some such examples, a slope of the curve can be utilized to determine characteristics of the leak. The leak parameter can correspond to a leakage rate, an amount of leakage, and/or a type/composition of fluid that has leaked. Additionally or alternatively, the leak characterization circuitry 704 is utilized to determine a total and/or aggregate amount of leaked fluid (e.g., over a known or determined time period).

An example calculation that can be performed by the leak characterization circuitry 704 is illustrated below. In this example, two conductor plates have an overlapping area al, and surface charge density to are placed parallel to each other as shown schematically in the examples of FIGS. 2A and 2B. The total electric field generates when the relative permeability constant β=1 is given by example Equation 1 and can yield example Equation 2:

$${E}_{0} = 4 π k σ \qquad ( 1 )$$

$$k = \frac{1}{4 π {ε}_{0}} , \qquad ( 2 )$$

where, ε₀=8.85×10⁻¹² C²N⁻¹m⁻². In this example, a dielectric plate of thickness d is used in between such that both of the conductor plates. The positioning of the dielectric plate between the conductor plate polarizes the dielectric plate. As a result, ±σ′ develops adjacent to the conductor plates. As a result, the electric field E₀ is produced between the two conductor plates with relatively no dielectric medium (β=1). Therefore, the changed electric field can be expressed by example Equations 3-5 below:

$$E = 4 π k σ - 4 π k {σ}^{′} \qquad ( 3 )$$

$$E = {E}_{0} ( 1 - \frac{{σ}^{′}}{σ} ) \qquad ( 4 )$$

$$E = \frac{{E}_{0}}{β} \qquad ( 5 )$$

In turn, the relative permeability constant β can be defined with example Equation 6 below:

$$\frac{1}{β} = 1 - \frac{{σ}^{′}}{σ} \qquad ( 6 )$$

The total amount of charge present over the conductor plate is defined by Q. The electric field extends perpendicular from the plate and up to infinity. However, the strength decreases as it moves away from the plate. Accordingly, it can be assumed that at infinity, E=0. Due to the developed electric field, voltage evolves such that voltage at infinity is V∞=0. In turn, as the variation in charge Q with V∞ follows a linear profile extending to infinity, a ratio of charge, Q to voltage, V yields self-capacitance, C at that point, as shown by example Equation 7:

$$C = \frac{Q}{V} \qquad ( 7 )$$

With the increase in the value of β, voltage decreases, which results in the increment in the initial self-capacitance value C₀ by a factor β as shown in example Equation 8 below:

$$C = β \times {C}_{0} \qquad ( 8 )$$

Quantitative evaluation of capacitance can be obtained if the type of the dielectric area α₁ and thickness of the dielectric d are known as shown in example Equation 9 below:

$$. C = \frac{β {ε}_{0} {α}_{1}}{d} \qquad ( 9 )$$

Therefore, capacitance is directly proportional to the area of the conductor a and inversely proportional to the separation distance d. The constant of proportionality is βε₀. The parameter, βε₀ depends on the type of dielectric and conductor material used as described by example Equation 6. As a result, the evaluation of βε₀ can be utilized for determining and/or characterizing self-capacitance of a system.

According to examples disclosed herein, the self-capacitance value is directly proportional to the change in dielectric constant of the cotton layer between an aluminum layer, for example, with the introduction of moisture due to leakage. As a result, the updated self-capacitance can be calculated as per example Equation 9. In some examples, a detection module can monitor and report the output value of the self-capacitance periodically (e.g., every 10 seconds, every minute, every 5 minutes, . . . etc.). If a value of self-capacitance is increased, a leakage is determined to be present and/or detected. A slope of a self-capacitance curve can be calculated and, in turn, an estimation of time of operation before failure (e.g., a leakage event, leakage above a threshold amount of leakage, etc.) is predicted. The slope of the curve may be based on analyzing a shape of the curve, for example. The example described above is only an example and any other appropriate methodology and/or calculation can be implemented instead.

In some examples, the leak characterization circuitry 704 is instantiated by programmable circuitry executing leak characterization instructions and/or configured to perform operations such as those represented by the flowchart of FIG. 8.

In some examples, the control interface circuitry 706 is implemented to control and/or direct of a system, a fluid management device, etc. In turn, the condition determination circuitry 706 can direct and/or provide information (e.g., leak presence information, leak characterization information, etc.) to a vehicle control system, such as the EFB 438 shown in FIG. 4. According to examples disclosed herein, the condition determination circuitry 706 may cause a transmitter and/or transceiver to wirelessly transmit the information to the vehicle control system 710. In some examples, the condition determination circuitry 706 is instantiated by programmable circuitry executing condition determination instructions and/or configured to perform operations such as those represented by the flowchart of FIG. 8.

While an example manner of implementing the leakage analysis system 700 of FIG. 1 is illustrated in FIG. 7, one or more of the elements, processes, and/or devices illustrated in FIG. 7 may be combined, divided, re-arranged, omitted, eliminated, and/or implemented in any other way. Further, the example data analyzer circuitry 702, example leak characterization analyzer circuitry 704, the example control interface circuitry 706, and/or, more generally, the example leakage analysis system 700 of FIG. 7, may be implemented by hardware alone or by hardware in combination with software and/or firmware. Thus, for example, any of the example data analyzer circuitry 702, example leak characterization analyzer circuitry 704, the example control interface circuitry 706, and/or, more generally, the example leakage analysis system 700, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example leakage analysis system 700 of FIG. 7 may include one or more elements, processes, and/or devices in addition to, or instead of, those illustrated in FIG. 7, and/or may include more than one of any or all of the illustrated elements, processes and devices.

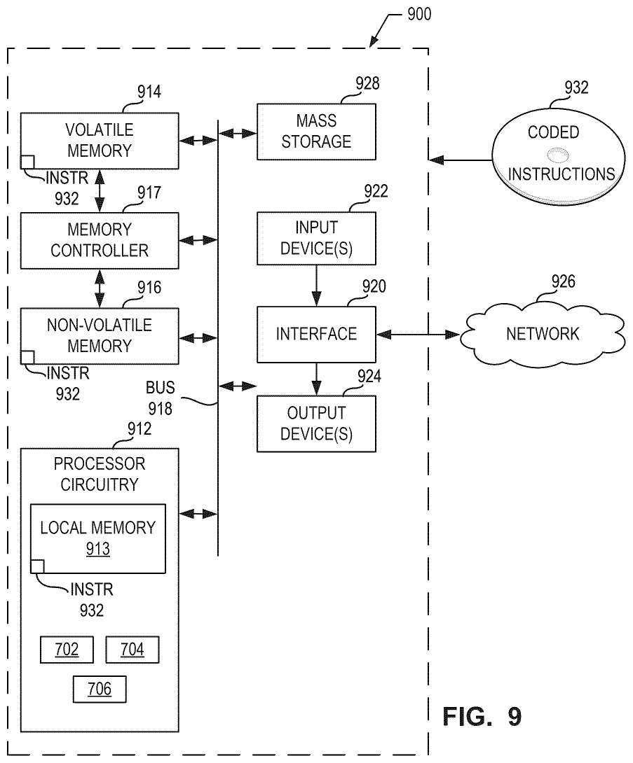

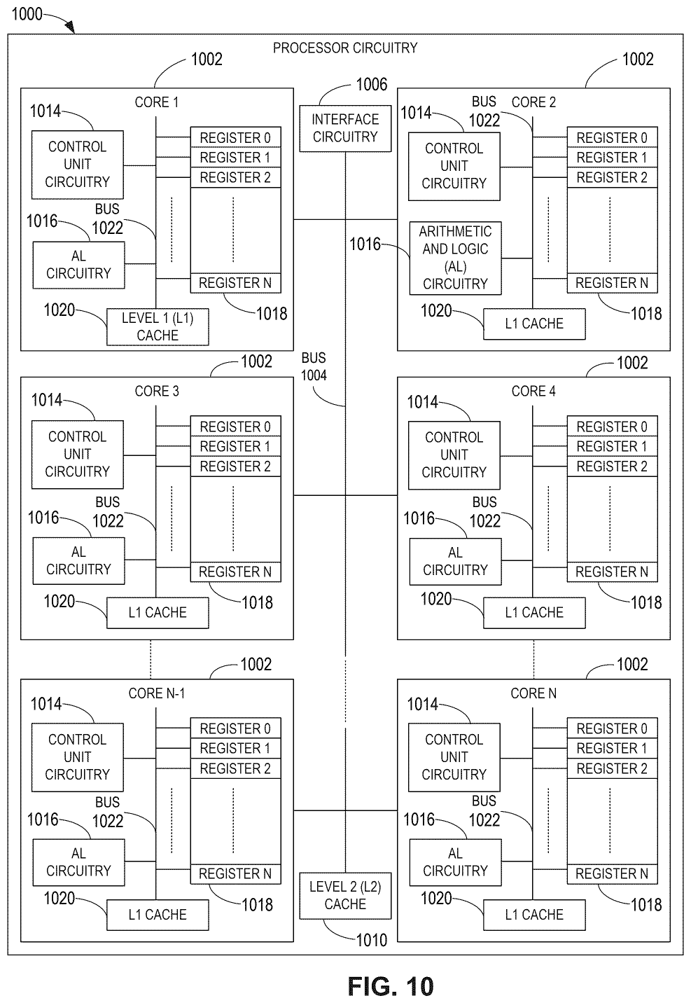

A flowchart representative of example machine readable instructions, which may be executed by programmable circuitry to implement and/or instantiate the leakage analysis system 700 of FIG. 7 and/or representative of example operations which may be performed by programmable circuitry to implement and/or instantiate the leakage analysis system 700 of FIG. 7, is shown in FIG. 8. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 8, many other methods of implementing the example leakage analysis system 700 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a flowchart representative of example machine readable instructions and/or example operations 800 that may be executed, instantiated, and/or performed by programmable circuitry to identify and/or characterize a leak in a system The example machine-readable instructions and/or the example operations 800 of FIG. 8 begin at block 801, at which the example data analyzer circuitry 702 selects and/or identifies a liquid/leak sensor to obtain signals therefrom. In some examples, the example data analyzer circuitry 702 utilizes an indication that a target (e.g., a leak target) will likely leak (e.g., based on data/predictions, etc.) to select the liquid/leak sensor.

At block 802, the data analyzer circuitry 702 measures, causes measurement of and/or determines the self-capacitance via a sensing circuit (e.g., the sensing circuit 402).

At block 804, the example leak characterization circuitry 704 generates a curve. In this example, the leak characterization circuitry 704 generates a curve that relates a self-capacitance and/or a slop of self-capacitance with respect to time. In some examples, the leak characterization circuitry 704 identifies and/or characterizes a linear portion of the curve.

At block 806, the leak characterization circuitry 704 of the illustrated example identifies a leak (e.g., a presence of a leak).

At block 808, additionally or alternatively, the leak characterization circuitry 704 determines at least one leak characteristic. For example, the leak characterization circuitry 704 may determine a leakage rate and/or a type of liquid that is leaking. Additionally or alternatively, a failure rate and/or failure prediction may be determined based on the leakage rate.

At block 810, it is determined whether to repeat the process. If the process is to be repeated (block 810), control of the process returns to block 801. Otherwise, the process ends. The determination may be based on whether additional monitoring of leakage is necessitated or desired.

FIG. 9 is a block diagram of an example programmable circuitry platform 900 structured to execute and/or instantiate the example machine-readable instructions and/or the example operations of FIG. 8 to implement the leakage analysis system 700 of FIG. 7. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements example data analyzer circuitry 702, example leak characterization analyzer circuitry 704, and the example control interface circuitry 706.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIG. 8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowchart of FIG. 8 to effectively instantiate the circuitry of FIG. 2 as logic circuits to perform operations corresponding to those machine readable instructions. In some such examples, the circuitry of FIG. 7 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIG. 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

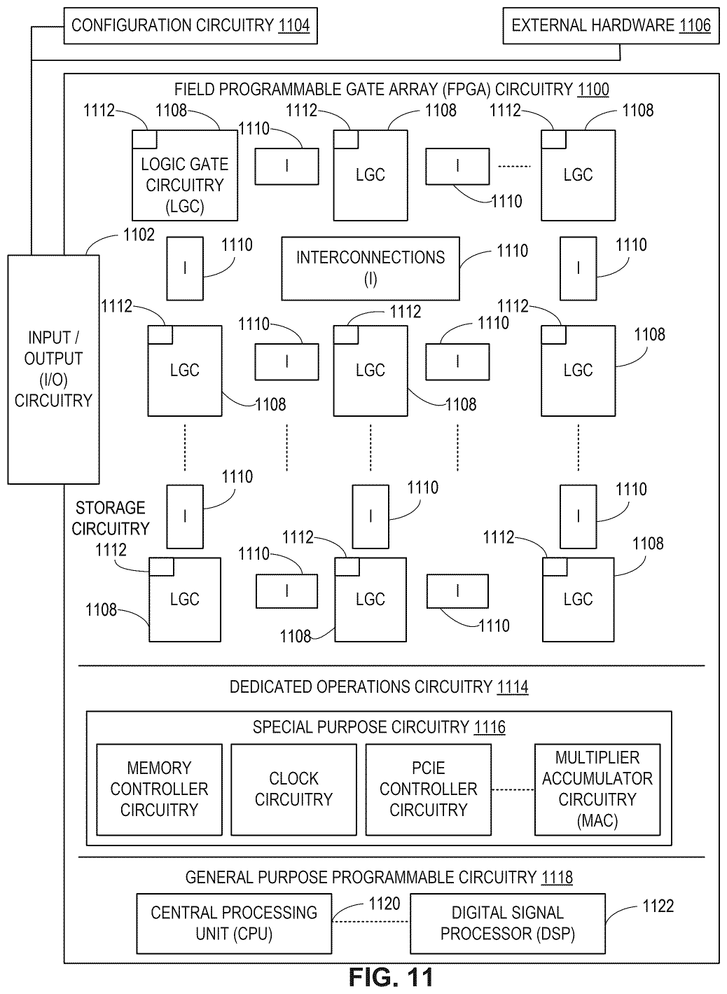

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart of FIG. 8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart of FIG. 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 8. As such, the FPGA circuitry 1100 may be configured and/or structured to effectively instantiate some or all of the operations/functions corresponding to the machine readable instructions of the flowchart of FIG. 8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIG. 8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIG. 8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart of FIG. 8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIG. 8, and/or an ASIC may be configured and/or structured to perform third operation(s)/function(s) corresponding to a third portion of the machine readable instructions represented by the flowchart of FIG. 8.

It should be understood that some or all of the circuitry of FIG. 7 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 7 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 7 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable cost-effective and lightweight leak determination/characterization are disclosed herein. Further examples and combinations thereof include the following:

Example 1 includes an apparatus to determine at least one of a presence of a leak or a characteristic of the leak corresponding to a target, the apparatus comprising a liquid sensor corresponding to the target, the liquid sensor including first and second electrodes, and a liquid transport material, wherein at least a portion of the liquid transport material is positioned between the first and second electrodes, and an inductor-capacitor resonance circuit electrically coupled to the first and second electrodes, the inductor-capacitor resonance circuit to measure a self-capacitance of the liquid sensor.

Example 2 includes the apparatus as defined in example 1, further including machine-readable instructions, and at least one processor circuit to be programmed by the machine-readable instructions to determine the self-capacitance of the liquid sensor with respect to time based on output from the inductor-capacitor resonance circuit, and determine at least one of the presence of the leak or the characteristic of the leak based on the self-capacitance.

Example 3 includes the apparatus as defined in example 2, wherein one or more of the at least one processor circuit is to determine a slope of a curve corresponding to the self-capacitance over time.

Example 4 includes the apparatus as defined in example 3, wherein one or more of the at least one processor circuit is to determine a leakage rate based on the slope.

Example 5 includes the apparatus as defined in example 3, wherein one or more of the at least one processor circuit is to determine a type of liquid corresponding to the leak based on the slope.

Example 6 includes the apparatus as defined in example 1, wherein the liquid transport material is a first liquid transport material, and wherein at least one of the first or second electrodes includes apertures that fluidly couple the first liquid transport material to a second liquid transport material proximate the target.

Example 7 includes the apparatus as defined in example 1, wherein the first and second electrodes are electrically coupled to a capacitor of the inductor-capacitor resonance circuit.

Example 8 includes the apparatus as defined in example 1, wherein the liquid transport material includes cotton fibers.

Example 9 includes at least one non-transitory machine-readable medium comprising machine-readable instructions to cause at least one processor circuit to at least determine a self-capacitance of a liquid sensor with respect to time based on output from a resonance circuit, the liquid sensor electrically coupled to conductors of a capacitor of the resonance circuit, the resonance circuit including a voltage source to supply power to the capacitor and an inductor of the resonance circuit, the liquid sensor including or in contact with a liquid transport material corresponding to a moisture target, and determine at least one of a presence of a leak or a characteristic of the leak based on the determined self-capacitance with respect to time.

Example 10 includes the at least one non-transitory machine-readable medium of example 9, wherein the machine-readable instructions are to cause one or more of the at least one processor circuit to determine a slope of a curve corresponding to the self-capacitance over time.

Example 11 includes the at least one non-transitory machine-readable medium of example 10, wherein one or more of the at least one processor circuit is to determine a leakage rate based on the slope.

Example 12 includes the at least one non-transitory machine-readable medium of example 11, wherein one or more of the at least one processor circuit is to determine a failure prediction based on the leakage rate.

Example 13 includes the at least one non-transitory machine-readable medium of example 10, wherein one or more of the at least one processor circuit is to determine a type of liquid corresponding to the leak based on the slope.

Example 14 includes the at least one non-transitory machine-readable medium of example 10, wherein one or more of the at least one processor circuit is to determine a shape of the curve to determine the slope.

Example 15 includes the at least one non-transitory machine-readable medium of example 9, wherein the machine-readable instructions are to cause a wireless transmitter to transmit data associated with the at least one of the presence of the leak or the characteristic of the leak to an aircraft control system.

Example 16 includes a resonance circuit for leakage identification in a vehicle, the circuit comprising an inductor, a capacitor in series with the inductor, a first lead of the capacitor electrically coupled to a first conductor of a liquid sensor, a second lead of the capacitor electrically coupled to a second conductor of the liquid sensor, the liquid sensor in contact with a liquid transport material, and a voltage source across the inductor and the capacitor.

Example 17 includes the circuit as defined in example 16, further including a microcontroller operatively coupled to the capacitor, the microcontroller to provide an output corresponding to a condition of the liquid sensor.

Example 18 includes the circuit as defined in example 17, further including a wireless transmitter to transmit the output to a vehicle control system.

Example 19 includes the circuit as defined in example 16, wherein the liquid sensor is a first liquid sensor, and further including a switch operatively coupled to the capacitor, the switch to cause one of the first liquid sensor or a second liquid sensor to be electrically coupled to the capacitor.

Example 20 includes a method comprising measuring a self-capacitance across a leak sensor associated with a transport material proximate to or at a target, and generating a curve corresponding to the self-capacitance of the leak sensor with respect to time, and determining at least one of a presence of leak or a characteristic of the leak based on the curve.

From the foregoing, it will be appreciated that example systems, apparatus, articles of manufacture, and methods have been disclosed that enable cost-effective and accurate leak determination. Examples disclosed herein can be relatively easy to implement. Further, examples disclosed herein can be implemented in a weight-saving manner, which can be particularly advantageous in vehicle applications, such as aircraft, for example. Disclosed systems, apparatus, articles of manufacture, and methods improve the efficiency of using a computing device by reducing a need for complex analyses that are computing resource intensive often associated with leak analysis systems. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to determine at least one of a presence of a leak or a characteristic of the leak corresponding to a target, the apparatus comprising:
a liquid sensor corresponding to the target, the liquid sensor including:
first and second electrodes; and
a liquid transport material, wherein at least a portion of the liquid transport material is positioned between the first and second electrodes; and
an inductor-capacitor resonance circuit electrically coupled to the first and second electrodes, the inductor-capacitor resonance circuit to measure a self-capacitance of the liquid sensor.

2. The apparatus as defined in claim 1, further including:
machine-readable instructions; and
at least one processor circuit to be programmed by the machine-readable instructions to:
determine the self-capacitance of the liquid sensor with respect to time based on output from the inductor-capacitor resonance circuit; and
determine at least one of the presence of the leak or the characteristic of the leak based on the self-capacitance.

3. The apparatus as defined in claim 2, wherein one or more of the at least one processor circuit is to determine a slope of a curve corresponding to the self-capacitance over time.

4. The apparatus as defined in claim 3, wherein one or more of the at least one processor circuit is to determine a leakage rate based on the slope.

5. The apparatus as defined in claim 3, wherein one or more of the at least one processor circuit is to determine a type of liquid corresponding to the leak based on the slope.

6. The apparatus as defined in claim 1, wherein the liquid transport material is a first liquid transport material, and wherein at least one of the first or second electrodes includes apertures that fluidly couple the first liquid transport material to a second liquid transport material proximate the target.

7. The apparatus as defined in claim 1, wherein the first and second electrodes are electrically coupled to a capacitor of the inductor-capacitor resonance circuit.

8. The apparatus as defined in claim 1, wherein the liquid transport material includes cotton fibers.

9. At least one non-transitory machine-readable medium comprising machine-readable instructions to cause at least one processor circuit to at least:
determine a self-capacitance of a liquid sensor with respect to time based on output from a resonance circuit, the liquid sensor electrically coupled to conductors of a capacitor of the resonance circuit, the resonance circuit including a voltage source to supply power to the capacitor and an inductor of the resonance circuit, the liquid sensor including or in contact with a liquid transport material corresponding to a moisture target; and
determine at least one of a presence of a leak or a characteristic of the leak based on the determined self-capacitance with respect to time.

10. The at least one non-transitory machine-readable medium of claim 9, wherein the machine-readable instructions are to cause one or more of the at least one processor circuit to determine a slope of a curve corresponding to the self-capacitance over time.

11. The at least one non-transitory machine-readable medium of claim 10, wherein one or more of the at least one processor circuit is to determine a leakage rate based on the slope.

12. The at least one non-transitory machine-readable medium of claim 11, wherein one or more of the at least one processor circuit is to determine a failure prediction based on the leakage rate.

13. The at least one non-transitory machine-readable medium of claim 10, wherein one or more of the at least one processor circuit is to determine a type of liquid corresponding to the leak based on the slope.

14. The at least one non-transitory machine-readable medium of claim 10, wherein one or more of the at least one processor circuit is to determine a shape of the curve to determine the slope.

15. The at least one non-transitory machine-readable medium of claim 9, wherein the machine-readable instructions are to cause a wireless transmitter to transmit data associated with the at least one of the presence of the leak or the characteristic of the leak to an aircraft control system.

16. A resonance circuit for leakage identification in a vehicle, the circuit comprising:
an inductor;
a capacitor in series with the inductor, a first lead of the capacitor electrically coupled to a first conductor of a liquid sensor, a second lead of the capacitor electrically coupled to a second conductor of the liquid sensor, the liquid sensor in contact with a liquid transport material; and
a voltage source across the inductor and the capacitor.

17. The circuit as defined in claim 16, further including a microcontroller operatively coupled to the capacitor, the microcontroller to provide an output corresponding to a condition of the liquid sensor.

18. The circuit as defined in claim 17, further including a wireless transmitter to transmit the output to a vehicle control system.

19. The circuit as defined in claim 16, wherein the liquid sensor is a first liquid sensor, and further including a switch operatively coupled to the capacitor, the switch to cause one of the first liquid sensor or a second liquid sensor to be electrically coupled to the capacitor.

20. A method comprising:
measuring a self-capacitance across a leak sensor associated with a transport material proximate to or at a target;
generating a curve corresponding to the self-capacitance of the leak sensor with respect to time; and
determining at least one of a presence of leak or a characteristic of the leak based on the curve.
